(19) United States
(12) Patent Application Publication
(10) Pub. No.: US 2002/0042772 A1
(43) Pub. Date: Apr. 11, 2002

(54) System and method for reconciling employment benefits

(76) Inventors: Jason M. Rudman, New York, NY (US); Janet Cataldo-Gebert, San Diego, CA (US); Patricia O. Alexander, Solana Beach, CA (US); Fabrizio Balestri, Cardiff by the Sea, CA (US); Jane Hughes, Long Beach, CA (US)

Correspondence Address: Snell & Wilmer LLP, One Arizona Center, 400 E. Van Buren, Phoenix, AZ, 85004-2202, US

(21) Appl. No.: 09/929,879

(22) Filed: Aug. 14, 2001

Related U.S. Application Data
(60) Provisional application No. 60/226,392, filed on Aug. 18, 2000.

(51) Int. Cl. G06F 17/60

(52) U.S. Cl. 705/38

(57) ABSTRACT

A system and method for third-party reconciliation of employment benefits is disclosed comprising a job matching service adapted to match candidate employee loan holders with employers where the employer pays a fee to at least partially offset the loan obligation of an employee upon commencement of employment. The present invention issues a funding request to the employer for subsequent reconciliation of payment to the servicer of the employee's loan to pay down the outstanding principal balance thereof as a benefit of employment.

### RELATED APPLICATIONS

The present application claims the benefit of, and priority to, U.S. Provisional Application No. 60/226,392 filed Aug. 18, 2000; the entire content of which is hereby incorporated by reference.

### FIELD OF THE INVENTION

This invention generally relates to reconciliation of employment benefits. More specifically, the invention relates to third-party reconciliation of loan payments made by an employer for the benefit of an employee in satisfaction of an employee's loan obligation, such as, a student loan obligation.

### BACKGROUND OF THE INVENTION

The consumer credit market has grown dramatically with the emergence and propagation of capital market economies. Indeed, most modern industrialized countries have many citizens that take on debt in order to secure immediate or accelerated access to various consumer goods and/or services. In the United States, this debt is growing dramatically on an individual consumer basis as well as in the aggregate. An average American consumer carries about nine credit cards, having an outstanding balance of several thousand dollars on each card. See “Debt and Bankruptcy”, Nolo Online Encyclopedia, http://nolo.com/encyclopedia, ©2001 Nolo.com, Inc. In the year 2000, the average American financed nearly $4,400 of consumer purchases, totaling $1.2 trillion in the United States. See “Hidden Credit Card Risks”, MSNBC Dateline NBC News, http://msnbc.com, ©2001 MSNBC. With five credit cards currently in circulation in the U.S. for every man, woman and child, consumer debt is at an all time high. Ibid. Indeed, recent bankruptcy filings indicate that the number of American consumers unable to service this debt is also increasing, prompting the U.S. Congress to recently modify the bankruptcy code to, inter alia, make it more difficult to qualify for eligibility to eliminate consumer debt in bankruptcy proceedings. See “Debt and Bankruptcy”, vide supra. As such, ample indications exist that the servicing of debt will continue to be a problem in the future for many generations of consumers.

As background, the common law concept of “debt” was generally a lawsuit seeking recovery of a discrete sum of money. For example, if a creditor could not precisely compute or otherwise determine the amount of money owed by the debtor, the creditor was required to resort to other legal mechanisms of recovery—not that of an action sounding in “debt.” In modern law, however, the meaning of the term “debt” is not so rigidly defined and may be regarded more generally as that which any person or legal entity owes to another—pecuniary or otherwise. See “Debt”, Microsoft® Encarta® Online Encyclopedia 2001, http://encarta.msn.com, ©1997-2001 Microsoft Corporation. One particular type of debt is known as “consumer debt” and generally refers to the short-term and intermediate-term debt used to finance the purchase of goods and/or services used for personal consumption. Consumer debt may be embodied as either cash loans or, in some cases, sales credit. In the modern industrialized world, as more people have come to be employed to earn regular income in the form of wages and salaries, and with the growth of successful mass marketing of durable consumer goods, debt financed through consumer credit has increased rather dramatically. See “Consumer Credit”, Britannica® Online Encyclopedia, http://britannica.com, ©2001 Britannica.com, Inc.

Additionally, many employers are experiencing difficulty attracting and retaining highly qualified human resources. This has led some employers to offer benefits to attract and retain the most qualified employees, such as, for example: paid holidays, vacation, personal leave, funeral leave, jury duty, military leave, sick leave, family leave, short and long-term disability insurance, medical insurance, dental insurance, vision plans, life insurance, retirement plans, stock options, profit sharing, bonuses, etc. Competition among market employers can often prompt individual employers to modify or otherwise improve their offering of benefits to prospective and existing employees in order to leverage an economic advantage in the human resources market. As can be seen from many of the above examples of employment benefits, this may often be accomplished by addressing the needs and/or desires of employees that would otherwise have to be met by the employee spending regular earned income.

There is a need, therefore, within the employment benefit and human resources art, to recognize and accommodate the needs of prospective and existing employees having consumer debt obligations which may be serviced by at least partial employer payment of an employee's consumer debt obligation as a benefit of employment. There is also a need to match prospective employees with employers that provide at least partial payment of employee consumer loans as a benefit of employment. There is also a need for third-party reconciliation of such consumer debt payments as a benefit of employment.

### SUMMARY OF THE INVENTION

In general, the present invention discloses an improved system and method for the reconciliation of employment benefits. More specifically, the present invention may be embodied as a job matching service for matching current loan holder employee candidates with employers, where the employer pays a fee to at least partially defray the loan obligation of the candidate employee upon commencement of employment. Once the matching engine successfully places the employee, information obtained from an employee's profile is used to coordinate a funding request to the employer and reconcile payment with the servicer of the employee's loan to pay down the outstanding principal balance and/or interest expense.

The candidate employee may be a student seeking a summer internship position, so the student accesses the system to create a student profile which may include, for example, personal identification data, information regarding outstanding student loans, skills and qualifications, internship preferences, etc. A data processing and matching engine then correlates the student's profile with employer profiles containing information such as, for example, available internship positions, required skills and qualifications, compensation data, benefit data, etc. After the student accepts an internship offer, the present invention issues a funding request to the employer. Thereafter, subsequent reconciliation of payment of the student's academic loan obligation is generally transparent to both the student intern and the employer.

The present invention thus provides for improved accommodation of the needs of prospective and/or existing employees having consumer debt obligations whereby the employee's debt is serviced, at least partially, by employer payment of the obligation. Moreover, the disclosed method also provides for (1) matching prospective employees with employers; and (2) third-party reconciliation of such consumer debt payments as a benefit of employment. Additional advantages of the present invention will be set forth in the detailed description which follows, and in part will be obvious from the detailed description, or may be learned by practice of the invention. The objects and advantages of the invention may be realized by means of the instrumentalities, methods and combinations particularly pointed out in the claims.

### BRIEF DESCRIPTION OF EXEMPLARY DRAWINGS

The above and other features and advantages of the present invention are hereinafter described in the following detailed description of illustrative embodiments to be read in conjunction with the accompanying drawings and figures, wherein like reference numerals are used to identify the same or similar system parts and/or method steps in the similar views, and:

FIG. 1 is a diagram of an exemplary system for matching employee candidates with available employment positions in accordance with one aspect of the present invention.

FIG. 2 is a diagram of an exemplary system for matching employee candidates with available employment positions in accordance with another aspect of the present invention.

FIG. 3 is a diagram of an exemplary system for matching employee candidates with available employment positions in accordance with yet another aspect of the present invention.

FIG. 4 is a diagram of an exemplary system for matching employee candidates with available employment positions in accordance with still another aspect of the present invention.

FIG. 5 is a flowchart of an exemplary method for matching employee candidates with available employment positions in accordance with one aspect of the present invention.

FIG. 6 is a flowchart of an exemplary method for third-party reconciliation of employer payment of an employee debt obligation in accordance with one aspect of the present invention.

### DETAILED DESCRIPTION OF EXEMPLARY EMBODIMENTS

The following descriptions are of exemplary embodiments of the invention, and are not intended to limit the scope, applicability or configuration of the invention in any way. Rather, the following description is intended to provide convenient illustrations for implementing various embodiments of the invention. As will become apparent, various changes may be made in the function and arrangement of the elements described in these embodiments without departing from the spirit and scope of the invention. Various exemplary implementations of the present invention may be applied to any employment benefit model utilizing, for example, a computer-based system and method for the reconciliation of employment benefits. Representative implementations include, for example, the payment of: student loans; automobile loans; recreational vehicle loans; marine loans; mortgages; secured and/or unsecured consumer loans; credit card debt; or any other type of loan and/or debt. As used herein, the terms “loan” and “debt”, or any variation thereof, includes anything that is currently susceptible to being characterized as any financial obligation or any similar characterization. By way of example, a detailed description of an exemplary application, namely the reconciliation and third-party payment of a student loan obligation, is provided as a specific enabling disclosure that may be generalized by those skilled in the art to any application of the disclosed system and method of employment benefit reconciliation in accordance with the present invention.

The subject invention relates to a process of reconciliation and third-party payment of employee debt obligations by an employer as a benefit of employment. One exemplary embodiment set forth herein relates to an employment benefit system and method for: (1) matching first-party students with internship employment opportunities; (2) at least partial second-party employer payment of a student loan held by the student intern; and (3) third-party reconciliation of the student loan payment. It will be appreciated, however, by one skilled in the art that the principles of the present invention may be employed to ascertain and/or realize any number of other benefits associated with employer payment of an employee debt obligation as a benefit of employment, but not limited to, providing incentives for attracting and/or retaining human resources.

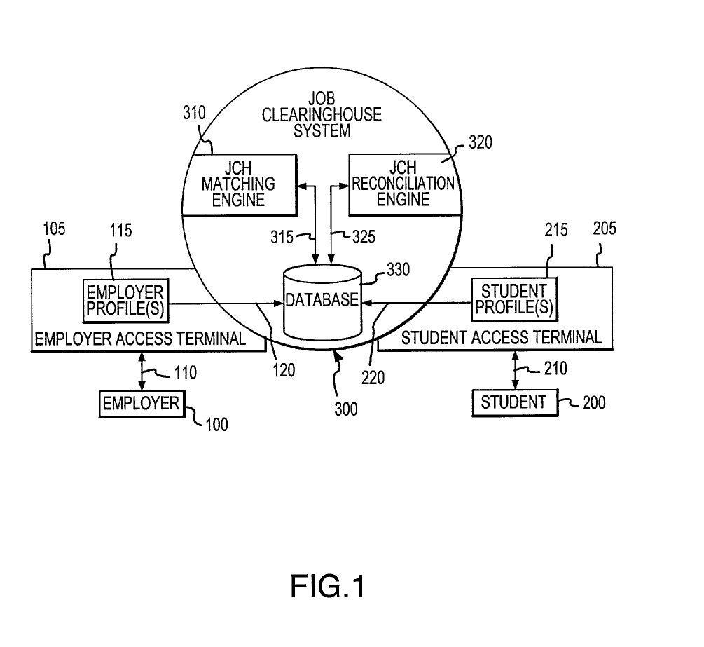

In accordance with one exemplary embodiment of the present invention, as depicted in FIG. 1, a computer-based Job Clearinghouse (“JCH”) system 300 (e.g., “third-party”) is disclosed, which comprises any software and/or hardware suitably configured for (1) matching students with internship employment opportunities; (2) at least partial employer payment of a student loan held by the student intern; and/or (3) third-party reconciliation of the student loan payment. In one embodiment, JCH system 300 includes: a matching engine 310; a reconciliation engine 320; and a database 330. As used herein, students, interns, employers, etc. include any person, organization, entity, group, software, hardware, business and/or the like.

Matching engine 310 is any software and/or hardware suitably configured to match students with opportunities. In accordance with one exemplary embodiment of the present invention, JCH matching engine 310 comprises any software and/or hardware system suitably adapted to retrieve and correlate employer profile data 115 with student profile data 215 stored in the JCH database 330. Additionally, the JCH reconciliation engine 320 comprises, for example, any software and/or hardware system suitably adapted to: retrieve and/or process data stored in JCH database 330; issue funding requests to an employer 100 (e.g., “second-party”); receive funds from an employer 100 in response to the funding request; route received funds to a financial institution; and/or notify the student 200 (e.g., “first-party”) when the financial institution has received funds. Matching engine 310 may also be configured to communicate with database 330 by a data communications path 315. Reconciliation engine 320 is any software and/or hardware suitably configured to reconcile loan data. Reconciliation engine 320 also may be similarly configured to communicate with database 330 by, for example, another data communications path 325.

The database 330 is configured to respond to queries and/or other database operations originating from, for example, the JCH matching engine 310. Additional components, such as, for example, Access Sequel Server, Oracle, Mysequel, Interbase, etc., may be used to provide, a suitable database management system. Database 330, however, may be any type of database, such as relational, hierarchical, object-oriented, flat file and/or the like. Common database products that may be used to implement database 330 include, for example, DB2 by IBM (White Plains, N.Y.), any of the database products available from ORACLE® CORPORATION (Redwood Shores, Calif.), MICROSOFT® ACCESS by MICROSOFT® CORPORATION (Redmond, Wash.), or any other database product now known or hereafter derived by those skilled in the art. Database 330 may be organized in any suitable manner, including, for example, data tables, look-up tables or any matchable data structures now known or hereafter derived by those skilled in the art.

Association of certain data in the database 330 may be accomplished through any data association technique known and practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field”; where said key field, for example, partitions the database according to a high-level class of objects defined by the key field. For example, a certain class may be designated as a key field in both a first data table and a second data table, and the two data tables may then be merged on the basis of the class data in the key field. In one embodiment, the data corresponding to a key field in each of the merged data tables is preferably the same. However, data tables having similar, though not identical, data in the key fields may also be merged by using AGREP, for example.

In one exemplary embodiment of the present invention, database 330, matching engine 310 and reconciliation engine 320 may be suitably adapted to reside on a computer-based server and/or host data processing system with communications paths 315 and 325 further comprising data stream transmission methods that include, for example: electronic; infrared; radio frequency; microwave frequency; optical; or any other I/O data stream method or protocol now known, or hereafter derived, by those skilled in the art. In an alternative exemplary embodiment, communications paths 315 and 325 may comprise a single shared I/O data path. In yet a further alternative exemplary embodiment in accordance with the present invention, database 330, matching engine 310 and reconciliation engine 320 may reside entirely or partially on a remote server or host data processing system, wherein communications paths 315 and 325 embody I/O data paths utilizing, for example, any number of data traffic protocols, such as: TCP/IP; IPX/SPX; Appletalk, IP6, NetBIOS, OSI or any existing or future data traffic protocols now known or hereafter derived by those skilled in the art.

In one embodiment of the present invention, the JCH system is adapted to receive information from, for example, an employer access terminal 105 and a student access terminal 205. Terminals 105 and 205 are any software and/or hardware suitably configured to provide their respective users (e.g., employer 100 and/or student 200) with a user interface, for example, to populate the JCH database 330 with profile data 115 and 215, respectively. The user interface provided by the employer terminal 105 or the student terminal 205 may comprise, for example: HTTP; HTTPS; HTML; XML, DHTML; ASP; CGI; a Windows application; an X-Windows application; ActiveX; Visual Basic script; Javascript; Perl script; a telnet session; an ftp session; a gopher session; a command line interface; a text-based interface; a graphic user interface or any user interface now known or hereafter derived by those skilled in the art. In one exemplary application, an employer 100 gains access to submit employer profile data 115 to the JCH system 300 for inclusion in the JCH database 330 by means of a data communications path 120. In a related exemplary application, a student 200 gains access to submit student profile data 215 to the JCH system 300 for inclusion in the JCH database 330 by means of another data communications path 220. Employer 100 and student 200 may interact with their respective terminals 105 and 205 by any number of I/O means (110 and 210, respectively), such as, for example: a monitor; a keyboard; a keypad; a mouse; a stylus; a lightpen; a digitizing tablet; a touch-screen; speech recognition; or any other I/O method now known or hereafter derived by those skilled in the art.

In one exemplary embodiment, employer profile data 115 may include any employer-related data, for example: employer identification; job opportunities; compensation information; benefits information; job location; employment qualifications; or the like. In another exemplary embodiment, student profile data 215 may include any student-related data, for example: student identification; school; year of graduation; major/minor fields of study; student loan information; GPA; career interests; willingness to relocate or the like.

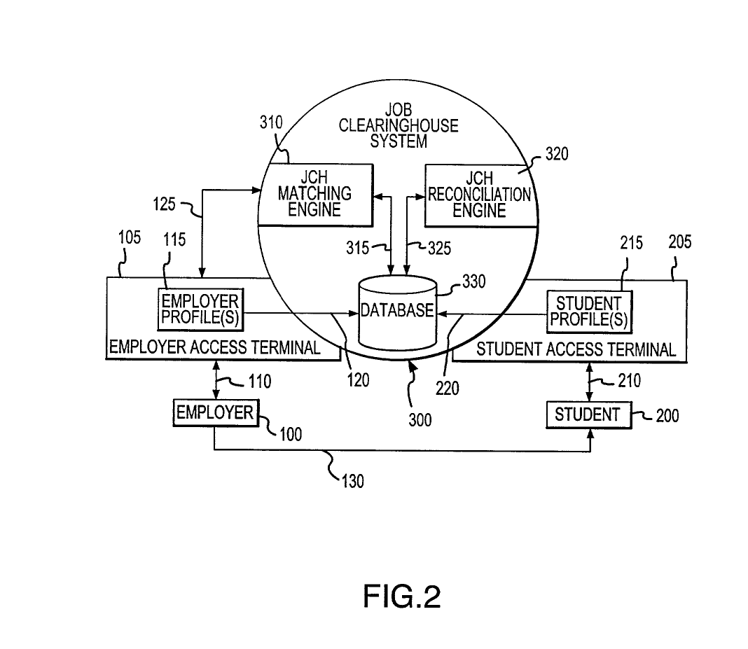

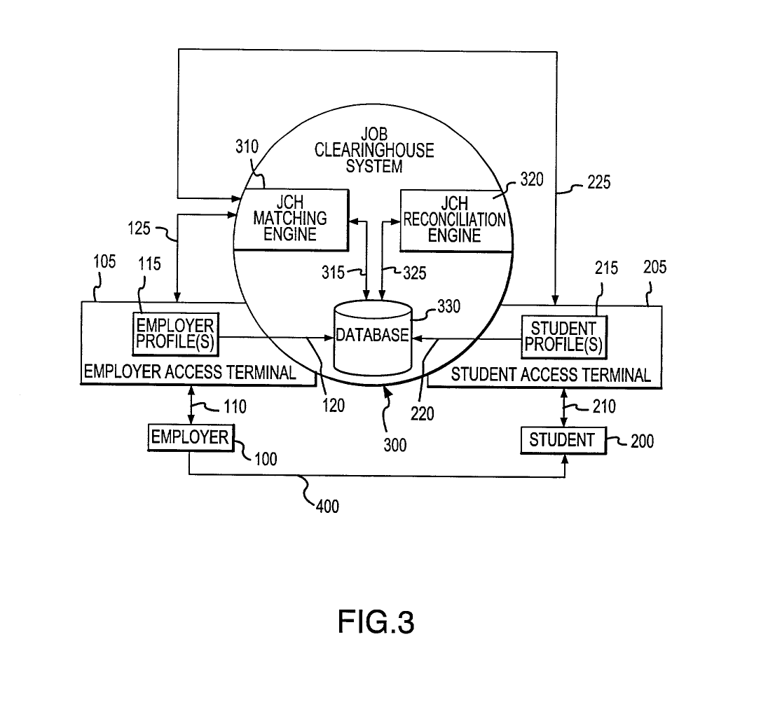

In one alternative exemplary embodiment, as depicted in FIG. 2, employer access terminal 105 may be further adapted to communicate with JCH matching engine 310 by means of a data communications path 125 in order to allow the employer 100 to selectively query the matching engine 310 to provide information relating to students 200 who may at least partially match the employer's criteria. In yet another exemplary embodiment, as depicted in FIG. 3, student access terminal 205 may be further adapted to communicate with JCH matching engine 310 by means of another data communications path 225 in order to allow the student 200 to selectively query the matching engine 310 to provide information relating to employers 100 who may at least partially match the student's criteria. Communications paths 125 and 225, in one embodiment, may comprise any I/O data path including, for example, any number of data traffic protocols, such as: TCP/IP; IPX/SPX; Appletalk, IP-6, NetBIOS, OSI or any existing or future data traffic protocol now known or hereafter derived by those skilled in the art.

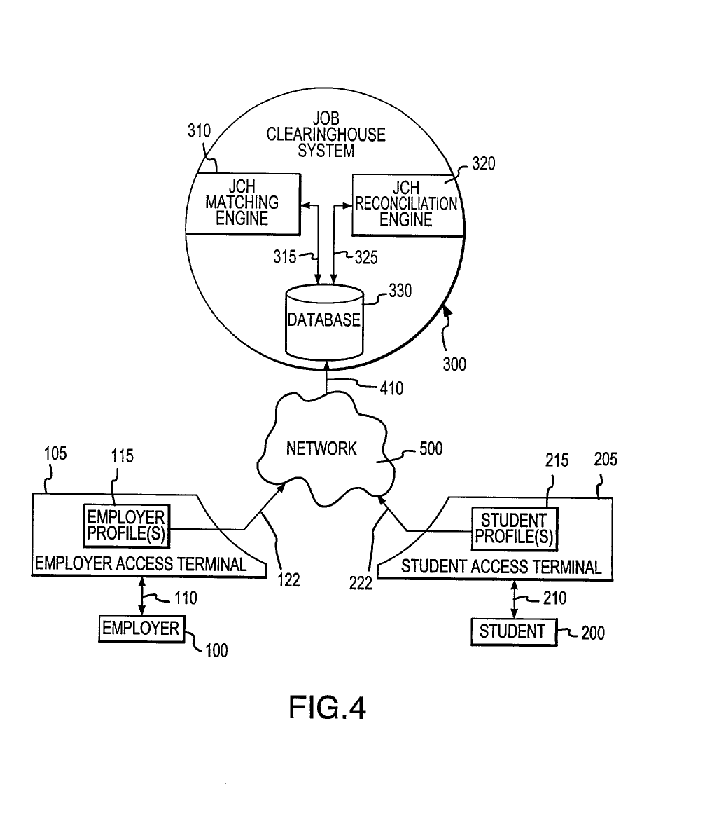

In yet a further exemplary embodiment in accordance with the present invention, as depicted in FIG. 4, student access terminal 205 and/or employer access terminal 105 may communicate with the JCH system 300 via network-based data communications paths (e.g., 122, 222, and 410), wherein communications paths 122, 222 and 410 may comprise any network I/O data path including, for example, any number of network data traffic protocols, such as: TCP/IP; IPX/SPX; Appletalk, IP-6, NetBIOS, OSI or any existing or future network data traffic protocols now known or hereafter derived by those skilled in the art.

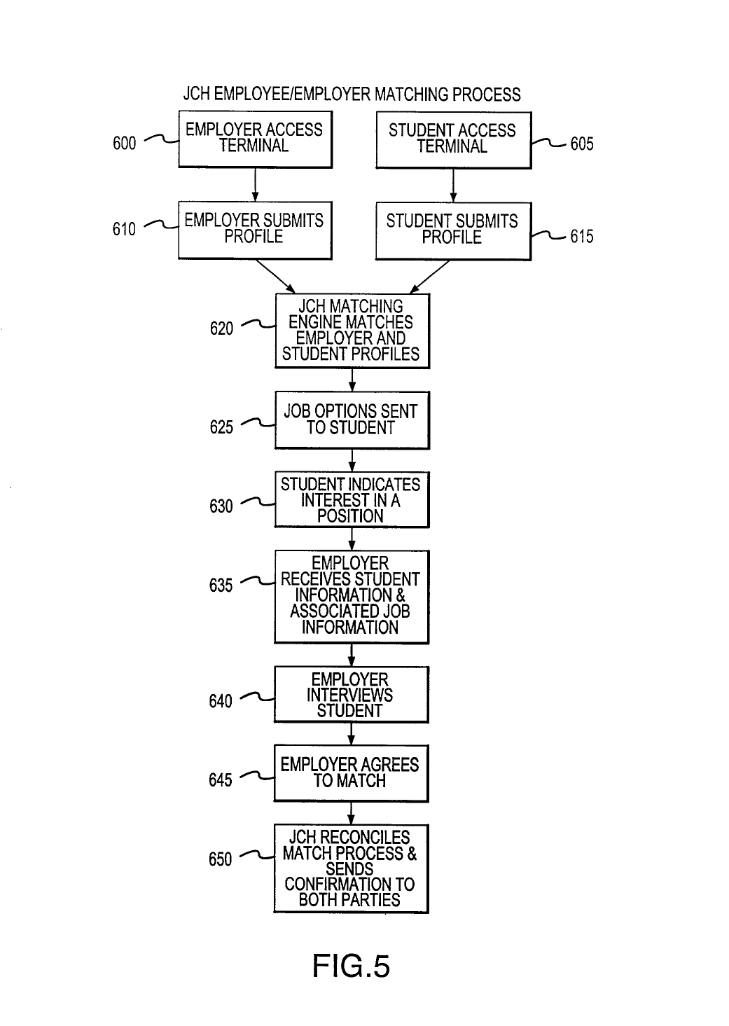

In general, with reference to FIG. 5, an exemplary aspect of the employment benefit reconciliation method in accordance with the present invention, may proceed with a student 200 accessing a terminal 205 (step 605) to create and submit a student profile 215 (step 615) to the JCH system 300. As previously described, JCH system 300, in one exemplary embodiment, comprises a computer-based data processing system and method configured for, inter alia, matching students with employment opportunities, wherein said employment opportunities include, as a benefit of employment, employer payment of a student's debt obligation, such as, for example, a student loan. JCH system 300 is further configured to receive employer profiles 115 from employers 100 (step 610) for correlation with student profiles 205 (step 620). In another exemplary embodiment, after the JCH system 300 matches a student profile 215 with employer profiles 115, employment options are presented to the student 200 (step 625); and student 200 thereafter identifies which of the presented employment options are desired (step 630). Alternatively, in accordance with another exemplary embodiment of the present invention, after the JCH system 300 matches an employer profile 115 with student profiles 215, candidate options are presented to the employer 100; employer 100 thereafter identifies which of the presented candidates are desired. The employer selects via any input means, now known or hereafter derived by those skilled in the art (for example: a check-box field, radio field, command button, text highlight, etc.), configured to indicate on the interface screen those individuals that employer 100 may be interested in pursuing for an interview to fill said position.

JCH system 300 then sends student profile information 215 and/or associated job information 115 to the prospective employers 100 identified from step 630 (step 635). Employer 100 may then interview the student 200 (step 640), and after a successful interview where the employer 100 agrees to offer the student 200 a position (step 645), the JCH system 300 completes the match process by, for example, recording the match and sending confirmation to the student 200 and the employer 100 (step 650). Additionally, employer 100 has the ability to re-enter the system to reconcile previous selections with the results obtained from the interview process, indicating if any prospective student 200 was successful or not. In one exemplary embodiment of the present invention, the JCH system 300 further issues a disbursement request to the employer 100 upon commencement of the student's employment—the employer will provide an estimated time of arrival for the job period (i.e., start date and period of employment) which will trigger, for example, an email to the employer to confirm completion of the period of employment that will be collected by the system; disbursed funds may then be substantially directly applied to offset, for example, the student's Stall academic loan obligation(s).

In another embodiment of the present invention, after the student 200 begins employment, the employer sends an electronic funds transfer (EFT) to an account accessible by the JCH system 300 for subsequent reconciliation of payment with the servicer(s) of the student employee's loan account(s). In an alternative exemplary embodiment, the JCH system 300 may be adapted to batch and reconcile multiple student loan payments with the servicers of multiple loan accounts belonging to a single student, or to batch and reconcile multiple student loan payments with the servicers of the loan accounts for multiple students. Batching may be accomplished, for example, using CommonLine file formatting, enabling the JCH system to collect relevant student information (i.e., successful completion of the employment; at least half-time attendance at an accredited Federal Family Education Loan Program (FFELP) institution; eligibility requirements as dictated by FFELP guidelines for qualification for a federal loan; in addition to other student loan information) and to send a subsequent EFT transaction to the individual borrower's loan servicer to apply the JCH payment to the individual student loan record.

In accordance with another exemplary embodiment of the present invention, student profiles 215 and employer profiles 115 are supplied to the JCH system 300 to populate the JCH database 330 as depicted in FIG. 1. With further reference to FIG. 2, another exemplary embodiment of the present invention includes a student access terminal 205 and an employer access terminal 105 for communicating with the profile database 330 and/or the JCH matching engine 310. Student 200 may submit their profile 215 for inclusion in the database 330 using an access protocol as previously described. Student access interface 205 may additionally be configured to provide student 200 with, for example, a graphic user interface (GUI) for entering student profile information 215 (step 605) for submission to the database 330 (step 615). In another exemplary embodiment, employer 100 may submit their profile 115 to the database 330 using an access interface 105 protocol as previously described. Employer access interface 140 may also be configured to provide employer 100 with, for example, a GUI for entering employer profile information 115 (step 600) for submission to the database 330 (step 610). In another exemplary embodiment of the present invention as previously described, employer access interface 105 may be suitably adapted to communicate with the JCH matching engine 310 to obtain a list of students 200 matching the employer's profile criteria 115. Thereafter, in another exemplary embodiment of the present invention, employer 100 contacts student 200, via communications path 130 (FIG. 2) to schedule an interview. Communications path 130 may include, for example: a telephone call, an Email message, a voicemail message, a letter or any method of personal communication now known or hereafter derived by those skilled in the art. In yet another exemplary embodiment of the present invention as previously described, student access interface 205 may be suitably adapted to communicate with the JCH matching engine 310 via data communications path 225 (FIG. 3) to obtain a list of employers 100 matching the student's profile 215. Such matching criteria may include, for example, location, student status and class, age, willingness to relocate or such similar considerations as when a person is looking for and applying for an open employment position.

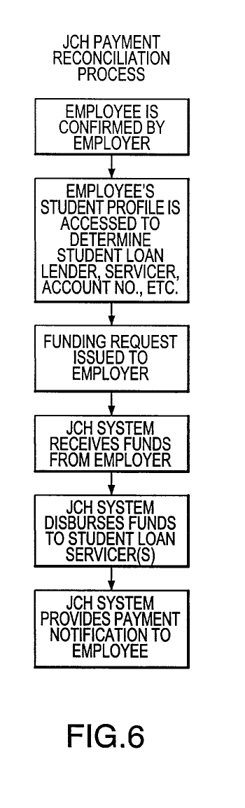

After an interview has been conducted and the employer 100 determines that there exists a favorable match, student 200 is hired and, in one exemplary embodiment of the present invention, the employer 100 notifies the JCH system 300 of the student's start date (step 700) as shown, for example, in FIG. 6. The JCH system 300 accesses the student's profile 215 (step 705) contained, for example, in the database 330 to determine the student loan lender, servicer, account number, etc., and then issues a student loan payment disbursement request (step 710) to the employer 100. When the student 200 arrives on site, an employer EFT is sent to transmit the debt payment benefit to the JCH system 300 (step 715). The reconciliation engine 320 of the JCH system 300 then disburses funds to the appropriate student loan servicer(s) (step 720).

In one embodiment of the present invention, as shown, for example, in FIG. 6, JCH reconciliation engine 320 is additionally configured to issue a notification of payment (step 725) to the student 200 after and/or concurrent with, for example, reconciliation of payment to the loan servicer (step 720). In an alternative exemplary embodiment, reconciliation of payment may be made to a plurality of student loan servicers either individually or as a result of a batch payment process.

In another exemplary embodiment of the present invention as previously described, students 200 and employers 100 communicate with the JCH matching engine 300 over a network 500 as generally depicted, for example, in FIG. 4. Additionally, the present invention anticipates that the database 330 may be hosted remotely from the JCH matching engine 310, in which case the communication link 315 between the matching engine 310 and the database 330 may also be embodied as a network connection. One skilled in the art will appreciate that such a network may include any system for exchanging data, such as, for example: the Internet; an intranet; an extranet; WAN; LAN; wireless communications protocol and/or the like. It is noted that the network may also be implemented as other types of networks, such as an interactive television (ITV) network.

In another exemplary embodiment, the system and method of reconciling an employment benefit according to the present invention includes a host server or other computing systems including a processor for processing digital data, a memory coupled to said processor for storing digital data, an input digitizer coupled to the processor for inputting digital data, an application program stored in said memory and accessible by said processor for directing processing of digital data by said processor, a display coupled to the processor and memory for displaying information derived from digital data processed by said processor and a plurality of databases, said databases including data that could be used in association with the present invention.

The present invention may be described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, matchable data structures, and the like, which may carry out a variety of functions under the control of one or more microprocessors or other control devices. Similarly, the software elements of the present invention may be implemented with any programming or scripting language such as, for example: C; C++; Java; COBOL; assembler; PERL; XML; etc., or any programming or scripting language now known or hereafter derived by those skilled in the art, with the various algorithms being implemented with any combination of data structures, objects, processes, routines or other programming elements. Further, it should be noted that the present invention may employ any number of conventional techniques for data transmission, signaling, data processing, network control, and the like. Still further, the invention may optionally be configured to use a client-side and/or server-side scripting language, such as JavaScript, VBScript or the like. Additionally, the present invention may be adapted or otherwise suitably configured to use and/or process encrypted data traffic. For a basic introduction of cryptography, see the text by Bruce Schneider entitled “Applied Cryptography: Protocols, Algorithms, And Source Code In C,” published by John Wiley & Sons (second edition, 1996), which is hereby incorporated by reference.

It should be appreciated that the particular implementations of the present invention shown and described herein are illustrative of the invention and the inventor's conception of the best mode and are not intended to otherwise limit the scope of the present invention in any way. Indeed, for the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The computing units may be connected with each other via a data communication network. The network may be a public network and assumed to be insecure and open to eavesdroppers. In one exemplary implementation, the network may be embodied as the Internet. In this context, the computers may or may not be connected to the Internet at all times. Specific information related to data traffic protocols, standards, and application software utilized in connection with the Internet may be obtained, for example, from DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997). LOSHIN, TCP/IP CLEARLY EXPLAINED (1997); all of these texts being incorporated herein by reference. A variety of conventional communications media and protocols may be used for data links, such as, for example: a connection to an Internet Service Provider (ISP) over the local loop as is typically used in connection with standard modem communication; cable modem; Dish networks; ISDN; Digital Subscriber Line (DSL) or various wireless communication methods. Employment benefit reconciliation systems, in accordance with the present invention, might also reside within a local area network (LAN), which interfaces to a network via, for example, a leased line (T1, T3, etc.). Such communication methods are generally well known in the art, and are covered in a variety of standard texts. See, e.g., GILBERT HELD, UNDERSTANDING DATA COMMUNICATIONS (1996), hereby incorporated by reference.

Users may interact with the system via any input device such as: a keyboard; mouse; kiosk; personal digital assistant; handheld computer (e.g., Palm Pilot®); telephone; mobile phone and/or the like. Similarly, the invention could be used in conjunction with any type of personal computer, network computer, workstation, minicomputer, mainframe, or the like running any operating system such as: any version of Windows; Windows XP; Windows Whistler; Windows ME; Windows NT; Windows 2000; Windows 98; Windows 95; MacOS; OS/2; BeOS; Linux; UNIX or any operating system now known or hereafter derived by those skilled in the art. Moreover, the invention may be readily implemented with TCP/IP communications protocols, IPX, Appletalk, IP-6, NetBIOS, OSI or any number of existing or future protocols. Moreover, the system contemplates the use, sale and/or distribution of any goods, services or information having similar functionality described herein.

As will be appreciated by one of ordinary skill in the art, the present invention may be embodied as a method, a system, a device, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Data communication is accomplished through any suitable communication means, such as, for example: a telephone network; Intranet; Internet; point of interaction device (personal digital assistant, telephone, mobile phone, kiosk, etc.); online communications; off-line communications; wireless communications and/or the like. One skilled in the art will also appreciate that, for security reasons, any databases, systems, or components of the present invention may consist of any combination of databases or components at a single location or at multiple locations, wherein each database or system includes any of various suitable security features, such as: firewalls; access codes; encryption; de-encryption; compression; decompression and/or the like.

The present invention is described herein with reference to block diagrams and flowchart illustrations of methods, apparatuses (e.g., systems), and computer program products according to various exemplary aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or any other programmable data processing device to produce a machine, such that the instructions which execute on the computer or other programmable data processing device create means for implementing the functions specified in the flowchart block or blocks.

These computer program instructions may also be stored in a computer-readable memory that can direct a computer or other programmable data processing device to function in a particular manner, such that the instructions stored in the computer-readable memory produce an article of manufacture including instruction means which implement the function specified in the flowchart block or blocks. The computer program instructions may also be loaded onto a computer or other programmable data processing device to cause a series of operational steps to be performed on the computer or other programmable device to produce a computer-implemented process such that the instructions which execute on the computer or other programmable device provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of the present invention. Accordingly, the scope of the invention should be determined by the appended claims and their legal equivalents, rather than by merely the examples given above. For example, the steps recited in any of the method or process claims may be executed in any order and are not limited to the order presented in the claims.

Benefits, other advantages, and solutions to problems have been described with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any variation thereof, are intended to cover a nonexclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”. Other combinations and/or modifications of the above-described structures, arrangements, applications, proportions, elements, materials or components used in the practice of the present invention, in addition to those not specifically recited, may be varied or otherwise particularly adapted by those skilled in the art to specific environments, manufacturing or design parameters or other operating requirements without departing from the general principles of the same.

We claim:

1. A method for reconciling at least partial payment of a first-party's consumer debt accounts, comprising the steps of:
issuing a funding request from a third-party reconciler to a second-party employer, said third-party reconciler comprising a computer-based data processing system and said second-party employer offering, as a benefit of employment, at least partial payment of at least one of said first-party's consumer debt accounts;
receipt of said funds by said third-party reconciler from said second-party employer; and
transferring said received funds from said third-party reconciler to a servicer of at least one of said first-party's consumer debt accounts.

2. The method for reconciling payment of a consumer debt, in accordance with claim 1, wherein said first-party is at least one of a full-time employee, a part-time employee, a freelance employee, a contractor, a sub-contractor, an independent consultant and an intern.

3. The method for reconciling payment of a consumer debt, in accordance with claim 1, wherein said data processing system includes a matching engine for correlating a candidate first-party with said second-party employer.

4. The method for reconciling payment of a consumer debt, in accordance with claim 3, wherein said matching engine is accessed, by means of a data network communications link by said candidate first-party looking for employment opportunities and a second-party employer offering employment opportunities.

5. The method for reconciling payment of a consumer debt, in accordance with claim 4, wherein the data traffic protocol of said data network communications link is at least one of an HTTP session, an HTTPS session, an ASP session, a DHTML session, an XML session, a CGI session, an ActiveX session, a Javascript session, a Visual Basic script session, a telnet session, an FTP session, and a gopher session.

6. The method for reconciling payment of a consumer debt, in accordance with claim 4, wherein said data network comprises at least one of the Internet, an intranet, an extranet, a WAN, a LAN, and a wireless communication network.

7. The method for reconciling payment of a consumer debt, in accordance with claim 3, wherein said matching engine is accessed with a graphic user interface.

8. The method for reconciling payment of a consumer debt, in accordance with claim 7, wherein said graphics user interface comprises a webpage.

9. The method for reconciling payment of a consumer debt, in accordance with claim 1, wherein said data processing system includes a database for storing information specific to said first-party.

10. The method for reconciling payment of a consumer debt, in accordance with claim 1, wherein said data processing system includes a database for storing information specific to said second-party employer.

11. The method for reconciling payment of a consumer debt, in accordance with claim 1, wherein said funding request is an electronic transaction.

12. The method for reconciling payment of a consumer debt, in accordance with claim 1, wherein said third-party transferal of funds is accomplished by an electronic transaction.

13. The method for reconciling payment of a consumer debt, in accordance with claim 1, wherein said third-party transferal of funds comprises a batch funding transaction for at least a plurality of first-parties to a single servicer.

14. The method for reconciling payment of a consumer debt, in accordance with claim 1, wherein said third-party transferal of funds comprises a batch funding transaction for at least a plurality of first-parties to at least a plurality of servicers.

15. The method for reconciling payment of a consumer debt, in accordance with claim 1, wherein said third-party reconciler notifies said first-party of reconciled payment of at least one of said first-party's consumer debt accounts.

16. The method for reconciling payment of a consumer debt, in accordance with claim 1, wherein said third-party reconciler notifies said second-party employer of reconciled payment of at least one of said first-party's consumer debt accounts.

17. A method of recruiting and retaining employees, comprising the steps of:
communicating an offer from a second-party to a first-party, said first-party having at least one consumer debt account with an outstanding balance and wherein said communicated offer is based upon at least partial payment of at least one of said first-party's consumer debt accounts as a benefit of employment;
issuing a funding request, by a third-party reconciler to said second-party employer, wherein said third-party reconciler comprises a computer-based data processing system;
receiving said funds, by said third-party reconciler from said second-party employer; and
transferring, by said third-party reconciler, said received funds to a servicer of at least one of said first-party's consumer debt accounts.

18. The method of recruiting and retaining employees, in accordance with claim 17, wherein said first-party is a prospective student intern, said second party is an employer and said consumer debt is an academic loan obligation.

19. The multiple application of the method of claim 17, wherein said second-party employer issues at least a plurality of said payments in at least partial satisfaction of at least one of said first-party's consumer debt obligations.

20. The multiple application of the method of claim 17, in accordance with claim 19, wherein said plurality of payments occurs on a chronometric basis selected from the group consisting of hourly, daily, weekly, bi-weekly, monthly, semi-monthly, quarterly, semi-quarterly, annually, semi-annually, bi-annually, regularly, randomly and any combination thereof.

21. A system for reconciling payment of a consumer debt account as a benefit of employment, comprising:
a first-party employee having at least one consumer debt account with an outstanding balance;
a second-party employer, wherein said second-party offers, as a benefit of employment, at least partial payment of at least one of said first-party employee's consumer debt accounts;
a computer-based data processing system configured to issue a funding request to said second-party employer;
said data processing system further configured to receive said funds from said second-party employer; and
said data processing system further configured to transmit said received funds, substantially directly, to a servicer of at least one of said first-party employee's consumer debt accounts.

22. A system for reconciling payment of a student's academic loan account as a benefit of employment, comprising:
a first-party student having at least one academic loan account with an outstanding balance;
a second-party employer, wherein said second-party offers, as a benefit of employment, at least partial payment of at least one of said first-party student's academic loan accounts;
a computer-based data processing system configured to issue a funding request to said second-party employer;
said data processing system further configured to receive said funds from said second-party employer; and
said data processing system further configured to transmit said received funds, substantially directly, to a servicer of at least one of said first-party student's academic loan accounts.
